(19) United States
(12) Patent Application Publication
(10) Pub. No.: US 2005/0260538 A1
(43) Pub. Date: Nov. 24, 2005

(54) Equipment for extracting root post prosthetic elements or implants

(75) Inventors: Alexandre Muller, Aix-en-Provence (FR); William Muller, Aix-en-Provence (FR)

Correspondence Address: EGBERT LAW OFFICES, 412 MAIN STREET, 7TH FLOOR, HOUSTON, TX, 77002, US

(73) Assignee: WAM (Societe Unipersonnelle a Responsabilite Limit, Marseille Cedex 13 (FR)

(21) Appl. No.: 10/518,796

(22) PCT Filed: Jun. 18, 2003
(86) PCT No.: PCT/FR03/01862

§ 371 Date: Jul. 11, 2005

(30) Foreign Application Priority Data
Jul. 2, 2002 (FR) 02/08258

(51) Int. Cl. A61C 3/14

(52) U.S. Cl. 433/159

(57) ABSTRACT

The invention concerns equipment for extracting root post prosthetic elements or implants, such as an instrument including two lever assembled together by a pivoting and non-intersecting articulation, each of the levers having a handle and an extracting branch extending on either side of the articulation such that when the two handles are brought closer together, the two extracting branches are spaced apart. The ends of the extracting branches of the instruments are curved so as to form an angle with the remaining part of the branches. There are U-shaped extracting end pieces designed to be removably positioned and pivotably mounted, at the curved ends of the extracting branches.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention presented here involves instrumentation for extracting prosthetic elements having a root post or for extracting implants. Its purpose is to allow the performance of this intervention in conditions of safety and speed that have not been realized until now, by means of a simple instrumentation, ease of manufacturing and usage.

### BACKGROUND OF THE INVENTION

The removal of dental prosthetic elements having metallic posts is actually a delicate operation that is dreaded by dental surgery practitioners because of its hazardous and dangerous nature for the integrity of the root carrying the post, in view of the fact that an improperly controlled extracting force applied to a post affixed in the root can cause the root to fracture.

Different instruments have already been proposed for performing the removal of dental prosthetic elements having metallic posts.

For example, in the document FR-2 559 053, a device is described for extracting the pivot of a tooth, consisting of a forceps whose two arms are connected to clamping jaws designed to cut the head of the pivot to be extracted, a rotating cam, a lever mounted on a rotating axis united with at least one of the two arms, a support instrument to be supported on the root of the tooth, this instrument being connected in a free manner to the arms or to the cam and consisting of a counter-cam acting together with the cam, the rotation of the cam being manually controlled and causing the movement of the assembly formed from the two arms and the jaws and the movement of the pivot relative to the root.

This device has the disadvantage of requiring an obstructive positioning when it is used, causing a lack of visibility and having an excessive volume when it is intended to intervene at the level of the posterior teeth. Moreover, its awkward operation requires, it seems, the use of both hands.

In the document FR-2 649 004, a device is described for extracting dental prostheses, crowns or the like, consisting of two levers, each having a handle and a clamp, the levers being connected, in a rotating manner so that the clamps are spread apart when the handles are brought together, a component structure being articulated to one of the clamps, the component structure being guided into a seat provided on the other clamp and supporting two opposing elements in the form of a clasp that can rotate in a plane perpendicular to the plane of the levers, the other clamp having stops fitted in order to rest on a zone of the mouth adjacent to a prosthesis to be extracted, the elements having the form of a clasp being designed in order to engage one side of the prosthesis while the clamps are moved toward each other, and in order to exert an extracting force against the supporting reaction of the stops on the zone of the mouth when the clamps are moved apart, the elements having the form of a clasp having two extensions between which a return spring is arranged, the spring being housed in a hole that goes through the component structure.

As in the above device, the use of this device requires it to be positioned so that it obstructs. On the other hand, during its use, one of the clamps of the forceps must be supported on the adjacent teeth so that it can not be used if those adjacent teeth are missing. In addition, the device described is quite complex.

In the document FR-1 064 933, a forceps is described, for the separation of pivots from pivot teeth that are fractured at the level of the root or that have been previously reduced to the level of the root, and on the accessible end of which are affixed, by being screwed on, a head comprised of a small screw plate. These forceps consist of two arms articulated around an axis but not crossed, these arms being terminated, at their rear part, in the form of forks made of a single piece with the rear part of the arms.

These forks can be straight or curved in a manner so as to make it possible to reach teeth that are further away.

In bringing together the arms of the forceps, the respective forks arranged between the root and the detachable head are spread apart and thus a force is exerted that is sufficient to extract the assembly of the detachable pivot head without subjecting the tooth itself to an extracting force.

One disadvantage of this entirely rigid forceps results from the fact that during the separation of the forks that comprise the end of the forceps, the forks go through a curved trajectory so that the extracting force applied to the post that one wants to extract is not exerted in a strictly axial direction, as is desirable, but with a strong lateral component that incurs risks of fissuring and fracture of the root if the root is fragile. In addition, the shape and the rigidity of the rear working part of the forceps does not make it possible to conveniently reach all of the teeth.

Another significant disadvantage of this forceps lies in the fact that when the post separates from the sealing material, because of the sizeable extracting force necessary for its separation, it can be suddenly projected to the outside with risks of injuring the patient or the practitioner.

The purpose of the present invention is to correct these disadvantages of the known devices for extracting dental posts, and notably, those of the type described in the documents FR-1 064 933.

### BRIEF SUMMARY OF THE INVENTION

To do this, the instrumentation according to the invention essentially consists of an instrument comprising two levers connected to each other, in their intermediate portion, in a rotating and non-crossing manner, by means of an articulation, each of these levers thus comprising one handle and one extracting arm extending on either side of the articulation, so that bringing together the two handles causes the two extracting arms to separate, this instrument being characterized in that the ends of the extracting arms are curved so as to form an angle with the remaining part of these extracting arms, and in that they comprise extracting tips in the form of clamps designed to be able to be positioned in a detachable way and with a rotational capacity, at the curved ends of the extracting arms.

Using this characteristic arrangement, when the extracting arms are separated in bringing together the handles, after having introduced the extracting clamps brought together in the space created by the practitioner between the root and the intrados of the prosthetic element, the element is subjected to an axial separation force and when the clamps move apart, the one supported on the intrados of the prosthetic element rotates slightly and stays parallel to the one supported on the top of the tooth so that the extracting force is always exerted in a strictly axial direction over the entire path of the separation movement. In this way, during this movement, the post is not subjected to bending forces likely to cause fissures or a fracture of the root.

In addition, the use of the instrument by vestibular access ensures a good visibility of the site.

The reduced obstruction of the working end of the instrument is equivalent to that of other instruments used by the practitioner of restorative dental surgery; moreover, the instrument is used only during the final phase of the intervention, the preparation of the site with verification (using the gauge described in the following) of the possibility for insertion of the working end of the instrument comprising the essential component of the intervention.

According to an advantageous embodiment mode of the invention, the instrument comprises mechanisms for subjecting the extracting arms to the action of progressive removal forces.

This arrangement prevents a sudden opening of the extracting arms causing a sudden ejection of the post or pivot.

According to another embodiment mode of the invention which is of interest, the instrument comprises a mechanism for automatically returning the extracting arms into a position close-together. In this way, the extracting clamps are always attached during the introduction of the active end of the instrument between the tooth support and the intrados of the prosthetic element.

According to another characteristic arrangement, the instrumentation according to the invention also consists of at least one gauge comprised of a flat bracket comprising a grasping part or sleeve and a working part whose end is formed by a calibrating fork. The thickness of this calibrating fork corresponds to the thickness of the pair of clamps of the extracting arms when they are in a position close together. The use of this gauge makes it possible to verify the diameter of the post to be extracted and the existence of a suitable separation between the root of the support tooth and the intrados of the prosthetic element, this space being prepared by the practitioner, in a customary manner, prior to the extraction operation of the prosthetic element as such.

### BRIEF DESCRIPTION OF THE SEVERAL VIEWS OF THE DRAWINGS

The above goals, characteristics, and advantages, and still others, are better understood from the description that follows and the attached drawings in which:

FIG. 1 is a view of the front of the instrument for extracting prosthetic elements having a root post or implants according to the invention, shown in the following position in which the two extracting clamps are attached.

FIG. 2 is a side view of this instrument.

FIG. 3 is a front view showing the extracting clamps in a separated position.

FIG. 4 is a perspective view of the instrument shown in the position of FIG. 3.

FIG. 5 is a detailed view, in an axial cross-section, of the working end of one of the rotating levers of the instrument, showing an example of detachable and rotating assembly of a clamp at the end of the extracting arm of the lever.

FIG. 6 is a side view of one of the detachable extracting clamps of the instrument.

FIG. 7 is a front view of this extracting clamp.

FIG. 8 is a front view of the gauge comprising a supplemental element of the instrument according to the invention.

FIG. 9 is a longitudinal section view along the line 9-9 of FIG. 8.

FIG. 10 is a perspective view showing the positioning of the pair of extracting clamps of the instrument around the shaft of the prosthetic element that is affixed in a dental root.

FIG. 11 is a detail view, showing the working end of the instrument, engaged between the top of the root and the intrados of the prosthetic element.

FIG. 12 is a perspective view similar to FIG. 10 and showing the separation distance of the clamps ensuring the extraction of the prosthetic element.

FIG. 13 is a detailed view similar to FIG. 11, showing the extraction of the prosthetic element.

FIG. 14 is a front view of another advantageous embodiment mode of the interchangeable extraction clamps.

FIG. 15 is a side view of this extraction clamp.

FIG. 16 is a plane view of FIG. 14.

### DETAILED DESCRIPTION OF THE INVENTION

Reference is made to the drawings in order to describe advantageous embodiment examples, though in no way restrictive, of the instrumentation according to the invention.

This instrumentation comprises an instrument for the extraction of prosthetic elements having a root post or of implants comprising two levers that are identical or roughly identical 1A, 1B, connected, in a non-crossed manner, by means of an axis of articulation 2. Each of these levers is arranged so as to comprise a handle 3A, 3B and an extraction arm 4A, 4B, extending on either side of the articulation axis 2. It is understood that bringing together the two handles 3A, 3B causes the separation of the two extracting arms 4A, 4B.

The handles 3A, 3B have a length longer than that of the extracting arms 4A, 4B.

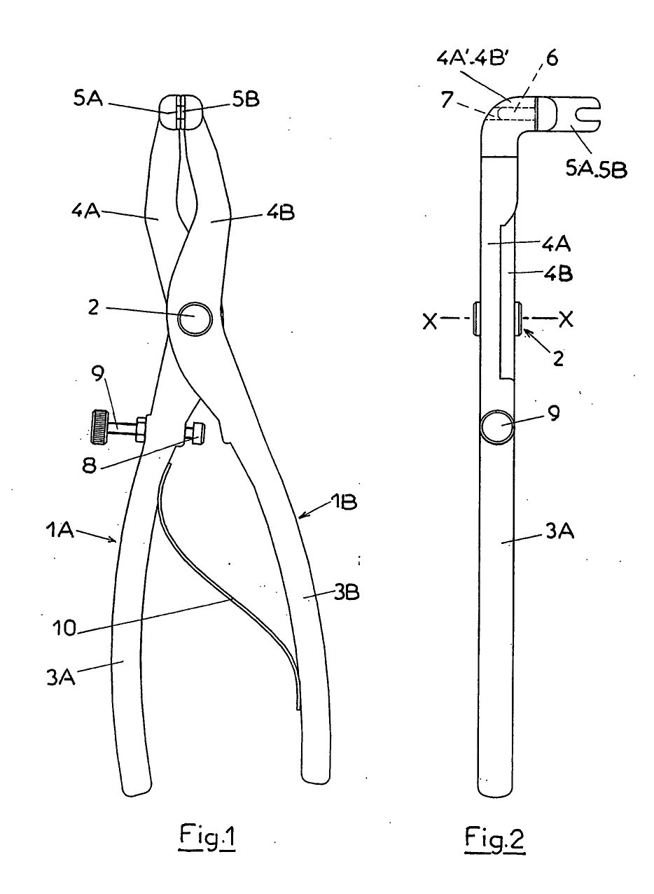

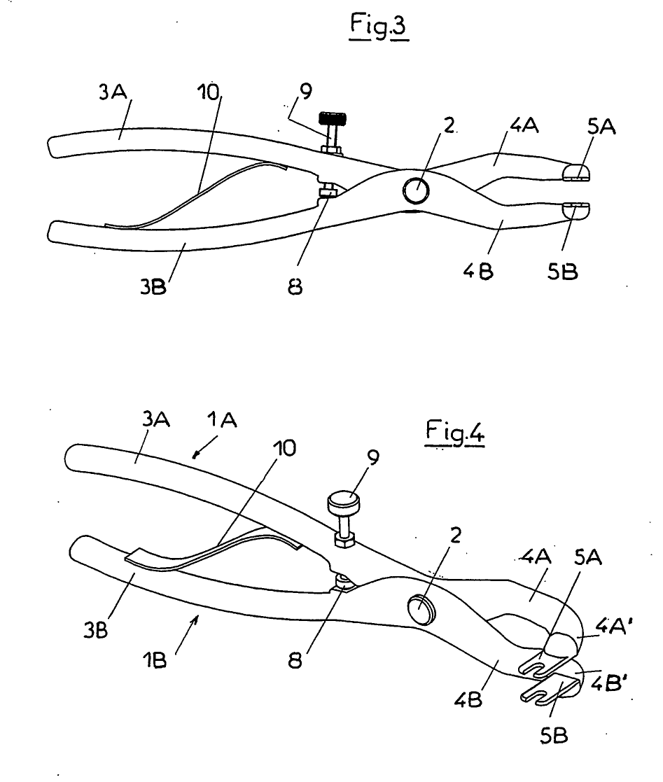

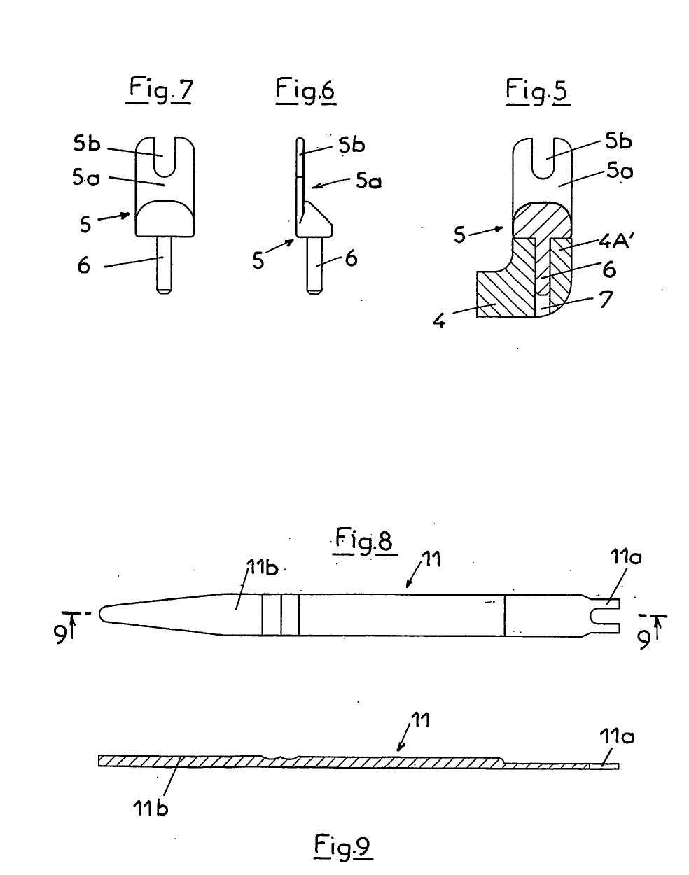

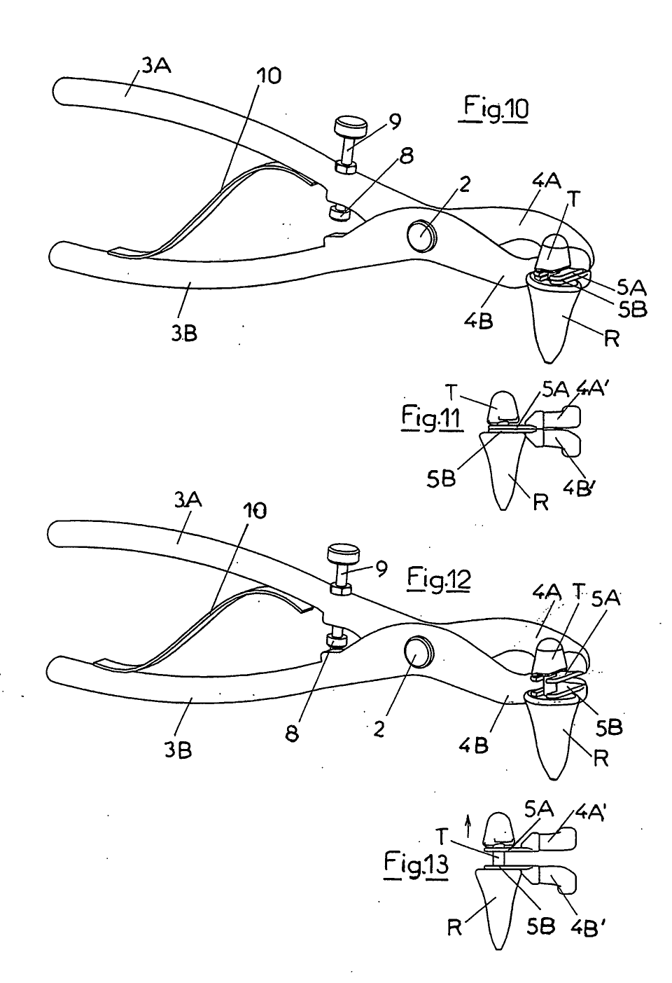

The extracting arms 4A, 4B are curved, their ends 4A′, 4B′, forming an angle with the remaining part of the arms, as shown notably in FIG. 2. Due to this arrangement, the working ends of the instrument remain parallel during their separation.

Each curved end 4A′, 4B′ of the arms 4A, 4B is arranged in order to allow the detachable and rotatable mounting of an extracting tip 5A, 5B in the form of a fork or clamp, this tip itself being activated in a supplemental manner in order to be able to be fixed in the extension of this end, in the conditions mentioned above.

The clamps 5 have a planar support surface 5a that is oriented to the outside and defines a notch 5b.

According to the example shown, the tips or clamps 5A, 5B comprise an extension made up of a shaft or cylindrical rod 6, while the bent end 4A′, 4B′ of the extracting arms 4A, 4B is equipped with a traversing bore 7. The diameters of the mounting shaft 6 and the bore 7 are provided in order to allow the insertion, without excessive play, of the shaft into the bore so that the clamp can be affixed without the possibility of untimely detachment, while still remaining able to rotate.

By this type of mounting, when the extraction of a prosthetic element T is performed, each extracting clamp 5A, 5B remains in continuous, perfect contact with its support surface, from the start to the end of the removal action of the arms 4A, 4B. More precisely, one of the clamps stays in maximum contact with the tooth root, while the other clamp stays in maximum contact with the intrados of the prosthetic element T. During its extraction, the post of the prosthetic element T is not subjected to any torsional force.

Preferably, the instrumentation according to the invention consists of several extracting clamps 5 sorted in pairs, the notches 5b of these pairs of clamps corresponding to different diameters of the posts of the prosthetic elements, these interchangeable pairs of clamps can also have different thicknesses. In this way, the practitioner can select a pair of clamps suited to the diameter of the post of the prosthetic element to be extracted and/or to the dimension of the space created between the root and the intrados of the element.

FIGS. 14 to 16 show another very important embodiment mode of the extracting tips, according to which the notch 5b′ of the working part 5a′ of the extracting tips 5′ has a decreasing width in the direction of the bottom of the notch. This notch can have the form of a V or have a spacing that decreases gradually.

These extracting tips are designed to allow and to make easier the removal of the simple root posts. Their purpose is to be able to adapt to the dimension of a small notch that the practitioner will have made beforehand, on either side of the post to be extracted. They also adapt to the diameter of the posts of the prosthetic elements. They also comprise a cylindrical rod 6′ that allows them to be affixed detachably to the end of the extracting arms of the extraction instrument.

According to an advantageous embodiment mode, the instrument according to the invention comprises mechanisms for subjecting the extracting arms to the action of forces of progressive removal.

These mechanisms can be comprised of a device designed to prevent the free connection of the handles 3A, 3B of the instrument. According to the example shown, this device is comprised of a flexible and compressible stop 8, for example, made of “Teflon” (registered trademark) and affixed to one of the handles (handle 3A) and arranged relative to an internal surface of the other handle (handle 3B), in a manner so that when the handles are brought together, this elastic stop is compressed between them. The elastic stop 8 is affixed to the end of a screw 9 that screws into the handle 3A, in a manner so as to allow the control of the support position of the stop.

Alternatively, this elastic stop can be affixed directly on one of the handles of the instrument, possibly relative to a controllable support instrument, affixed to the other handle.

Prior to bringing the handles 3A, 3B together, the position of the flexible stop 8 is adjusted, if necessary, so that the stop comes to be supported against the handle 3B. When the handles 3A, 3B are connected, the crushing of the flexible stop 8 puts up a progressive resistance, which in order to continue, requires a tightening action on the handle. In this way, a progressive removal of the extracting clamps 5A, 5B is obtained, preventing the sudden ejection of the loose prosthetic element T.

According to another embodiment mode which is of interest, the instrument is further equipped with a mechanism for automatic return of the extracting arms 4A, 4B, into a position close together. This mechanism can be comprised of a leaf spring 10 placed between the handles 3A, 3B of the instrument and tending to push apart the handles, and, as a result, to bring together extracting arms 4A, 4B. In this way, the extracting clamps 5A, 5B are automatically in an attached position, i.e. in the desirable position to engage in the extraction action after the practitioner has created the necessary space between the root of the tooth support and the intrados of the prosthetic element, in order to engage the attached extracting clamps.

In order to control the adequate dimension of the space arranged by the practitioner, the instrumentation according to the invention also comprises preferably at least one gauge 11 comprised of a flat bracket, straight or curved, comprising a prehensile part 11b and a working part whose end is formed from a calibrating fork 11A. The width of this calibrating fork 11A corresponds to the width of a pair of clamps 5A, 5B positioned at the ends of the extracting arms 4A, 4B, respectively, when the arms are attached.

In an advantageous manner, the instrumentation comprises a set of several gauges 11 having calibrating forks 11 a which correspond to different diameters of posts of the prosthetic elements T and to different sizes of the extracting clamps 5. In this manner, after having verified the dimension of the space created between the root R and the intrados of the prosthetic element and the diameter of the post of this element, the practitioner can adapt the pair of clamps corresponding to these measurements, on the extracting arms of the instrument.

FIGS. 10 and 11 show the extraction of a prosthetic element having a root post T sealed in a tooth root R.

In FIGS. 10 and 11, it is shown that the attached clamps 5A-5B of the instrument have been engaged in the space E prepared by the practitioner, using the customary techniques and equipment, and “encircling” the post of the prosthetic element T, the handles 3A, 3B being spread apart.

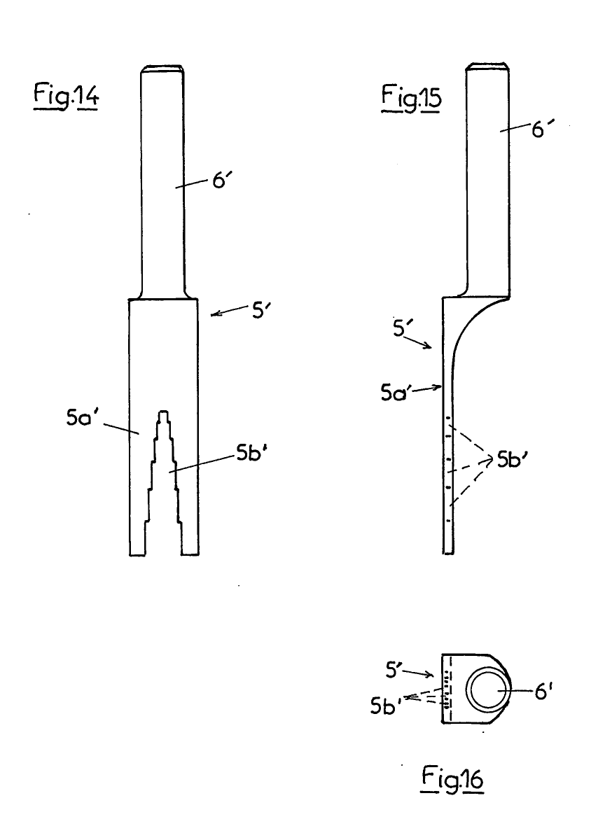

In FIGS. 12 and 13, the handles have been moved together, causing the separation of the arms 4A, 4B and the extracting clamps 5A, 5B, this separation communicating an axial extracting movement to the prosthetic element T ensuring that it is pulled out.

1. Instrumentation for extracting prosthetic elements having a root post or for extracting implants, comprising:
two levers connected to each other, in a rotating and non-crossing manner, by an articulation, each lever being comprised of a handle and an extracting arm extending on either side of the articulation wherein bringing together two handles causes two extracting arms to separate, wherein ends of the extracting arms are curved so as to form an angle with a remaining part of the extracting arms, and wherein the ends are comprised of extracting tips as clamps, positionable in a detachable way and with a rotational capacity, at curved ends of the extracting arms.

2. Instrumentation according to claim 1, further comprising: a plurality of pairs of extracting clamps having different thicknesses and having notches corresponding to different diameters of prosthetic element posts.

3. Instrumentation according to claim 1, further comprising: a plurality of mechanisms for subjecting the extracting arms to action of progressive separating forces.

4. Instrumentation according to claim 1, further comprising: a mechanism for automatic return of the extracting arms into a position close together.

5. Instrumentation according to claim 1, further comprising: at least one gauge comprised of a flat bracket comprising a grasping part or sleeve and a working part having an end comprised of a calibrating fork, a thickness of said calibrating fork corresponding to thickness of the pair of clamps of the extracting arms (4A, 4B) when the arms are in a position close together; wherein said gauges have calibrating forks corresponding to different diameters of prosthetic element posts and different sizes of extracting clamps.

6. Instrumentation according to claim 1, wherein said clamps a planar support surface oriented to an outside and defining a notch.

7. Instrumentation according to claim 6, wherein said notch has a decreasing width in a direction to a bottom of the notch, said notch being in a shape of a V or a spacing that decreases gradually.

8. Instrumentation according to claim 1, wherein the extracting clamps comprise a shaft or cylindrical rod, and wherein the bent ends comprised of a traversing bore permitting the detachable and rotatable mounting of the clamps in the extension of the ends.

9. Instrumentation according to claim 3, wherein said mchanisms for subjecting the extracting arms to the progressive removal forces comprise a flexible and compressible stop affixed to one of the handles, relative to an internal surface of the other handle such that when the handles are brought together, said elastic stop is compressed therebetween.

10. Instrumentation according to claim 9, further comprising: a mechanism for regulating support of the elastic stop.

11. Instrumentation according to claim 4, wherein said mechanism for automatic return of the extracting arms to a close together position is comprised of a leaf spring interposed between the handles tending to separate said handles.
